(19) United States
(12) Patent Application Publication
(10) Pub. No.: US 2018/0030395 A1
(43) Pub. Date: Feb. 1, 2018

(54) METHOD FOR PRODUCING A FOOD PRODUCT BASED ON VINEGAR CREAM AND CHEESE CREAM AND A PRODUCT OBTAINED USING SUCH METHOD

(71) Applicant: ACETIFICIO CARANDINI EMILIO S.P.A., Castelnuovo Rangone (MO) (IT)

(72) Inventor: Giovanni CARANDINI, Castelnuovo Rangone (MO) (IT)

(21) Appl. No.: 15/548,497

(22) PCT Filed: Jul. 29, 2016
(86) PCT No.: PCT/IB2016/054567

§ 371 Date: Aug. 3, 2017

(30) Foreign Application Priority Data
Aug. 6, 2015 (IT) 102015000042523

(51) Int. Cl. C12J 1/08; A23C 19/09; A23C 19/076

(52) U.S. Cl. CPC C12J 1/08; A23C 19/076; A23C 19/09

(57) ABSTRACT

A method for producing a food product based on vinegar cream and cheese cream, comprises the steps of providing at least one vinegar cream and at least one cheese cream, mixing at least one vinegar cream with at least one cheese cream in respective predetermined amounts, so as to obtain a food product having the characteristics of stability with long periods of preservation as well as particularly unique and pleasant flavour.

### TECHNICAL FIELD OF THE INVENTION

The present invention regards a method for producing a food product based on vinegar cream and cheese cream and a product obtained using such method.

In particular, the present invention regards a method for obtaining a food product based on vinegar cream and cheese cream that allows to obtain a food product with a particularly unique and pleasant flavour, as well as with long preservation period, suitable to maintain the edibility, nutritional value and organoleptic characteristics thereof unaltered.

### STATE OF THE PRIOR ART

In the food industry, there is an ever-growing offer of food products proposed by producers to consumers seeking for new and unique flavours.

In particular, over the last years there has been an increasing use of products like creams, condiments, and the like, based on food products such as cheese (and other food products) to be used combined with other dishes and recipes to confer a particular flavour, or even alone.

However, most food products of this type reveal some drawbacks, due to the fact that they have rather limited preservation period due to the characteristics of the ingredients used.

### OBJECTS OF THE INVENTION

Thus, the technical task of the present invention is to provide a method for obtaining a food product based on vinegar cream and cheese cream that allows to obtain a food product with particularly unique and pleasant flavour, so as to be appealing to the consumer, and that has a long preservation period, suitable to maintain the edibility, nutritional value and organoleptic characteristics thereof unaltered.

Within this technical task, obtaining a food product based on vinegar cream and cheese cream that can be obtained in a simple and economic manner represents a particular object of the present invention.

This task and this object are attained by the method for producing a food product based on vinegar cream and cheese cream according to the enclosed claim 1.

The method for producing a food product based on vinegar cream and cheese cream, comprises the steps of providing at least one vinegar cream and at least one cheese cream, mixing at least one vinegar cream with at least one cheese cream in respective predetermined amounts, so as to obtain a food product having the characteristics of stability with long periods of preservation as well as particularly unique and pleasant flavour.

In addition, the same object is attained by a food product comprising at least one vinegar cream and at least one cheese cream mixed together, so as to obtain a final food product having the characteristics of stability with long preservation period as well as with particularly unique and pleasant flavour.

Further features and advantages are described in the dependent claims.

### EMBODIMENTS OF THE INVENTION

The method for producing a food product based on vinegar cream and cheese cream, comprises the steps of providing at least one vinegar cream and at least one cheese cream, mixing at least one vinegar cream with at least one cheese cream in respective predetermined amounts, so as to obtain a food product having the characteristics of stability with long periods of preservation as well as with a particularly unique and pleasant flavour.

In particular, in a first embodiment of the method, the aforementioned vinegar cream could be obtained through the steps of mixing grape must and/or grape juice with vinegar, balsamic vinegar and caramel, adding a first thickener, so as to obtain suitable thickness and viscosity of said vinegar cream. The balsamic vinegar used is preferably the Balsamic Vinegar of Modena PGI. The Balsamic Vinegar of Modena PGI is made up of wine vinegar, grape must and at least 10-year aged vinegar, kept in barrels for at least two months; caramel may be optionally added before or after the storage in barrels. The Balsamic Vinegar of Modena PGI is approved by the pertinent Organisation designated to control.

In a second embodiment of the method, the vinegar cream can be obtained through the steps of mixing grape must and/or grape juice with vinegar and with a condiment either based on vinegar and grape must or based on vinegar and grape juice, adding a first thickener, so as to obtain suitable thickness and viscosity of said vinegar cream.

The vinegar may be white wine vinegar and/or red wine vinegar and/or even de-coloured wine vinegar and/or apple cider vinegar and/or derivatives of vinegar. The grape must and/or grape juice may be of the white and/or red type, fresh, cooked, concentrated, rectified, and the like.

In said second embodiment of the method, the vinegar cream is preferably obtained through the steps of mixing white grape must and/or white grape juice with white vinegar and with a white condiment either based on white vinegar and white grape must or based on white vinegar and white grape juice, adding a first thickener, so as to obtain suitable thickness and viscosity of said vinegar cream.

The expression cream is used to indicate a preparation with a creamy density, even thick or dense.

The aforementioned thickener is preferably modified starch. This does not exclude the use of any other thickener suitable for the purpose.

In particular, the thickener is added using a powder shaker machine.

The aforementioned cheese cream is obtained by mixing—at a predetermined temperature—at least cheese, water, milk, emulsifying salt and/or at least one derivative of milk, for example but not exclusively, milk whey, butter, milk cream, yoghurt. The addition of such emulsifying salt during heating, for example at 90° C. for a pre-set period of at least 20 minutes, allows to form a bond between the liquid ingredients even in the presence of a fat substance (such as milk, cheese, butter, milk cream, yoghurt) and to obtain a compact, viscous and homogeneous product.

In particular, the cheese cream comprises an amount of cheese at a percentage comprised between 10% and 70% of the total. Preferably, the amount of cheese is equivalent to 25% of the cream cheese.

Preferably, the cheese used to obtain the cream cheese is Parmigiano Reggiano, in particular Parmigiano Reggiano PDO. Other embodiments providing for the use of other types of cheese are not excluded.

More in detail, the cheese cream may be obtained by mixing Parmigiano Reggiano PDO, at a percentage equivalent to 25% of the total, water, milk whey, butter, milk protein, emulsifying salt, acidity corrector and a second thickener. Preferably, the emulsifying salt is sodium citrate, the acidity corrector is citric acid, and the second thickener is carrageenan.

The milk used for obtaining the cheese cream is preferably whole milk.

More in detail, the method comprises the steps of mixing said vinegar cream with said cheese cream at pre-set amounts respectively comprised between 50% and 95% of the total for vinegar cream and comprised between 5% and 50% of the total for cheese cream.

Preferably, the method comprises the steps of mixing said vinegar cream with the cheese cream at pre-set amounts respectively comprised between 55% and 85% of the total for vinegar cream and comprised between 5% and 35% of the total for cheese cream.

In particular, with reference to the first embodiment of the method of the present invention, which comprises the use of balsamic vinegar, preferably Balsamic Vinegar of Modena PGI, the method could comprise the steps of providing grape must, preferably concentrated grape must, or grape juice, preferably concentrated grape juice, at a percentage comprised between 20% and 70%, wine vinegar at a percentage comprised between 3% and 25%, balsamic vinegar at a percentage comprised between 3% and 25%, caramel at a percentage comprised between 1% and 9%, a first thickener at a percentage comprised between 0.1% and 9%, and cheese cream at a percentage comprised between 5% and 50%.

Even more in particular, with reference to the first embodiment of the method of the present invention, which comprises the use of balsamic vinegar, preferably Balsamic Vinegar of Modena PGI, the method could comprise the steps of providing grape must, preferably concentrated, or grape juice, preferably concentrated, at a percentage comprised between 35% and 55%, wine vinegar at a percentage comprised between 10% and 15%, balsamic vinegar at a percentage comprised between 10% and 20%, caramel at a percentage comprised between 2% and 4%, a first thickener at a percentage comprised between 2% and 4%, cheese cream at a percentage comprised between 25% and 35%.

With reference to the second embodiment of the method of the present invention, which comprises the use of a condiment of the white type, the method could comprise the steps of providing concentrated white grape must or concentrated white grape juice at a percentage comprised between 20% and 70%, white wine vinegar at a percentage comprised between 5% and 40%, condiment either based on white vinegar and concentrated white grape must or based on white vinegar and concentrated white grape juice at a percentage comprised between 5% and 40%, a first thickener at a percentage comprised between 0.1% and 9%, cheese cream at a percentage comprised between 5% and 40%.

Preferably, with reference to the second embodiment of the method of the present invention, the method could comprise the steps of providing concentrated white grape must or concentrated white grape juice at a percentage comprised between 35% and 55%, white wine vinegar at a percentage comprised between 15% and 25%, condiment either based on white vinegar and concentrated white grape must or based on white vinegar and concentrated white grape juice at a percentage comprised between 10% and 20%, a first thickener at a percentage comprised between 2% and 4%, cheese cream at a percentage comprised between 15% and 25%.

The step of mixing the vinegar cream and the cheese cream is carried out using a dough making machine/mixer.

Preferably, the mixing occurs under cold conditions using a cutter provided with large blades so as to mix and blend the ingredients that have a high viscosity and thickness, which would otherwise remain separated. The mixing of the vinegar cream, of the acid type, and the cheese cream, of the fat type, is carried out by a dough making machine/mixer, without adding additives or catalysts, as well as even without heating due to the fact that it could alter the organoleptic characteristics of the product.

In particular, the first thickener added to the vinegar cream, the emulsifying salt and the second thickener added to the cheese cream promote the appropriate final mixing of the two creams, obtained—as mentioned—without any additional ingredient but simply by exploiting the mechanical action of the dough making machine/mixer.

All the ingredients used may be of organic origin and/or conventional.

It is also an object of the present invention a food product comprising at least one vinegar cream and at least one cheese cream mixed, so as to obtain a final food product having the characteristics of stability with long preservation period as well as with particularly unique and pleasant flavour.

According to one of the embodiments of the present invention, the food product comprises at least one vinegar cream as previously described and at least one cheese cream as previously described, mixed together.

It is also an object of the present invention a food product obtained through the method herein described.

The food product, obtained by mixing together the two vinegar and cheese creams, acquires the inherent stability characteristics typical of products containing wine vinegar and grape must; thus, the obtained food product is easy to handle and similar to food products of viticulture origin.

In particular, the mixing of the vinegar cream with the cheese cream allows to increase the basic acidity of the final food product and to obtain a suitable viscosity thereof, thus to counter-balance the absence of acidity and the high doughiness of the cheese cream alone.

Thus, the described method allows to obtain a food product having suitable basic acidity values and an ideal thickness and homogeneity (with low levels of free water), thus guaranteeing long preservation periods at room temperature, at least six months and up to two or three years, according to the microbiological analysis carried out.

The invention thus conceived allows to obtain important technical advantages.

An important technical advantage lies in the fact that the method for obtaining the food product based on vinegar cream and cheese cream, as described above, allows to obtain a finished product with long preservation periods, due to the microbiological and final acidity characteristics attained, due to the optimal mixing of the vinegars—of the types and in the proportions described above—with the other ingredients. Thus, the organoleptic characteristics, the edibility and the nutritional value of the food product remain unaltered over a longer period of time with respect to products of the known type.

In addition, the described method allows attaining a food product with particularly unique and pleasant flavour, and it may be taken combined with dishes, in recipes or even alone, thus appealing to the consumer.

Furthermore, the method for producing a food product based on vinegar cream and cheese cream as described above can be implemented in a simple and economic way.

Though the present invention has been described according to preferred embodiments, technically equivalent embodiments may be conceived without departing from the scope of protection offered by the claims that follow.

1. A method for producing a food product based on vinegar cream and cheese cream, characterised in that it comprises the steps of providing at least one vinegar cream and at least one cheese cream; mixing at least said at least one vinegar cream with said at least one cheese cream in respective predetermined amounts, so as to obtain a food product having the characteristics of stability with long periods of preservation.

2. Method according to claim 1, wherein said vinegar cream is obtained through the steps of mixing grape must and/or grape juice with vinegar, balsamic vinegar and caramel; adding at least one first thickener, so as to obtain suitable thickness and viscosity of said vinegar cream.

3. Method according to claim 1, wherein said vinegar cream is obtained through the steps of mixing grape must and/or grape juice with vinegar and with a condiment either based on vinegar and grape must or based on vinegar and grape juice; adding a first thickener, so as to obtain suitable thickness and viscosity of said vinegar cream.

4. Method according to any one of the preceding claims, wherein said vinegar is white wine vinegar and/or red wine vinegar and/or de-coloured wine vinegar and/or apple cider vinegar, and wherein said grape must and/or said grape juice are of the white and/or red type, fresh, cooked, concentrated, rectified, and the like.

5. Method according to any one of the preceding claims, wherein said first thickener is modified starch.

6. Method according to any one of the preceding claims, wherein said cheese cream is obtained by mixing, at a predetermined temperature, at least cheese, water, milk, emulsifying salt and/or at least one milk derivative.

7. Method according to claim 6, wherein the step of mixing at least cheese, water, milk, emulsifying salt and/or at least one milk derivative occurs simultaneously with heating, in particular at 90° C. for a pre-set period of at least 20 minutes.

8. Method according to claim 6 or 7, wherein said cheese cream comprises an amount of cheese at a percentage comprised between 30% and 70% of the total.

9. Method according to claim 6 or 7 or 8, wherein said cheese is Parmigiano Reggiano.

10. Method according to any one of the preceding claims 6 to 9, wherein the milk is whole milk.

11. Method according to any one of the preceding claims, comprising the step of mixing said vinegar cream with said cheese cream at pre-set amounts respectively comprised between 50% and 95% of the total for vinegar cream and comprised between 5% and 50% of the total for cheese cream.

12. Method according to any one of the preceding claims, comprising the steps of providing concentrated grape must or concentrated grape juice at a percentage comprised between 20% and 70%, wine vinegar at a percentage comprised between 3% and 25%, balsamic vinegar at a percentage comprised between 3% and 25%, caramel at a percentage comprised between 1% and 9%, first thickener at a percentage comprised between 0.1% and 9%, cheese cream at a percentage comprised between 5% and 50%.

13. Method according to any one of the preceding claims 1 to 11, comprising the steps of providing concentrated white grape must or concentrated white grape juice at a percentage comprised between 20% and 70%, white wine vinegar at a percentage comprised between 5% and 40%, condiment either based on white vinegar and concentrated white grape must or based on white vinegar and concentrated white grape juice, said condiment being at a percentage comprised between 5% and 40%, first thickener at a percentage comprised between 0.1% and 9%, cheese cream at a percentage comprised between 5% and 40%.

14. Method according to any one of the preceding claims, wherein said step of mixing said vinegar cream with said cheese cream is carried out using a dough making machine/mixer.

15. Method according to claim 14, wherein said dough making machine/mixer is a cutter.

16. Method according to any one of the preceding claims 5 to 15, wherein said step of adding thickener is carried out through a powder shaker machine.

17. Food product, characterised in that it comprises at least one vinegar cream and at least one cheese cream mixed so as to obtain a food product having the characteristics of stability with long periods of preservation.

18. Food product according to claim 17, characterised in that the vinegar cream comprises grape must and/or grape juice with vinegar, balsamic vinegar, caramel and at least one first thickener, and in that the cheese cream comprises at least cheese, water, milk, emulsifying salt and/or at least one milk derivative.

19. Food product according to claim 17, characterised in that it is obtained through the method according to any one of claims 1 to 16.
